(19) United States
(12) Patent Application Publication
(10) Pub. No.: US 2006/0153199 A1
(43) Pub. Date: Jul. 13, 2006

(54) Apparatus and method for guaranteeing fairness among a plurality of subscribers in subscriber network

(76) Inventors: Hyoung Il Lee, Daejeon-city (KR); Jeong Hee Lee, Daejeon-city (KR); Dae Geun Park, Daejeon-city (KR); Bhum Cheol Lee, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/295,415

(22) Filed: Dec. 6, 2005

(30) Foreign Application Priority Data
Dec. 7, 2004 (KR) 10-2004-0102506
Apr. 22, 2005 (KR) 10-2005-0033525

(51) Int. Cl. H04L 12/56; H04L 12/28

(52) U.S. Cl. 370/395.4

(57) ABSTRACT

An apparatus and method for guaranteeing fairness among a plurality of subscribers in a subscriber network are provided. The apparatus includes: a packet classification unit which classifies a plurality of packets received via at least one physical port by the subscribers; and a packet processing unit which performs a scheduling operation on the classified packet according to output order of the subscribers. Accordingly, it is possible to guarantee a fair allocation of bandwidth to the subscribers, even when the subscriber network is expanded to have an arbitrary topology.

### CROSS-REFERENCE TO RELATED PATENT APPLICATION

This application claims the benefit of Korean Patent Application Nos. 10-2004-0102506, filed on Dec. 7, 2004, and 10-2005-0033525, filed on Apr. 22, 2005, in the Korean Intellectual Property Office, the disclosures of which are incorporated herein in their entirety by reference.

### BACKGROUND OF THE INVENTION

1. Field of the Invention

The present invention relates to an apparatus and method for guaranteeing fairness among end users in a subscriber network, and more particularly, to an apparatus and method for guaranteeing fairness among end users even when the subscriber network is expanded to have an arbitrary topology.

2. Description of the Related Art

FIG. 1 is a diagram of an ideal subscriber network in which fairness among a plurality of end users is guaranteed. In a subscriber network, it is important to ensure fairness among a plurality of end users, i.e., subscribers, in terms of the opportunities to access one or more uplinks. To this end, a subscriber network may be ideally established by using an apparatus 100 for guaranteeing fairness among a plurality of subscribers having a large capacity, as illustrated in FIG. 1. The apparatus 100 can manage all of a plurality of subscriber ports under the same conditions, can measure variations in subscriber traffic in real time, and can effectively handle the variations in the subscriber traffic. However, in order to establish the subscriber network of FIG. 1, a subscriber line aggregation apparatus having a large capacity is needed. Thus, the subscriber network of FIG. 1 is considered costly and ineffective in terms of expandibility.

FIG. 2 is a diagram of a tree structure representing a subscriber network that guarantees fairness among a plurality of end users. Referring to FIG. 2, the subscriber network is realized with a tree structure by using a plurality of apparatuses 200, 210, 211, 212, . . . , 21k in order to guarantee fairness among a plurality of subscribers. In other words, in the subscriber network, all of the subscribers are placed at the same level in the tree structure, i.e., at the same depth below a root node of the tree structure connected to an uplink. Thus, even though the subscriber network of FIG. 2 is less sophisticated than the subscriber network of FIG. 1 in which subscriber traffic is handled by using one apparatus for guaranteeing fairness among a plurality of subscribers in a subscriber network, all of the subscribers are more likely to be treated equally in the subscriber network of FIG. 2 than in the subscriber network of FIG. 1 because, in the subscriber network of FIG. 2, the subscribers are serviced at the same level.

In the subscriber network of FIG. 2, all of the subscribers are located at a plurality of lowermost nodes of the tree structure, and thus, the plurality of apparatuses 200, 210, 211, 212, . . . 21k for guaranteeing fairness among a plurality of subscribers in a subscriber network are needed. In addition, the subscriber network of FIG. 2 cannot be expanded without reorganizing the tree structure.

For example, a 3:1 subscriber line aggregation apparatus can accommodate a total of 9 subscribers by branching three sibling nodes from the root node of the tree of FIG. 2. In order to accommodate a total of 10 subscribers while satisfying the condition that all of the 10 subscribers are placed at the same depth below the root node of the tree structure of FIG. 2, 4 sibling nodes must branch from the 3 sibling nodes of the root node of the tree structure of FIG. 2. Accordingly, a total of 8 (=1+3+4) nodes are needed to accommodate 10 subscribers. In addition, in order to equally service all of the subscribers in the subscriber network of FIG. 2, the apparatuses 200, 210, 211, 212, and 21k must exchange information, which increases the communication and computational workload of the subscriber network of FIG. 2.

FIG. 3 is a diagram of a subscriber network that can be expanded to have an arbitrary topology. Referring to FIG. 3, the subscriber network, which includes a plurality of apparatuses 300, 310, 320, 330, and 340, can be easily expanded since it consumes less resources and a smaller management burden than other subscriber networks. However, the subscriber network may not be able to ensure fairness among a plurality of subscribers 1 through 10. For example, the subscriber 1 can access an uplink via a smaller number of apparatuses in the subscriber network than the subscriber 8, and thus the traffic of the subscriber 1 is less likely to collide with the traffic of another subscriber. In addition, the subscriber 1 is likely to be serviced with a larger bandwidth than the subscriber 8. Thus, the subscribers 1 through 10 in the subscriber network may be unequally serviced.

A conventional apparatus in a subscriber network having an arbitrary topology may classify a plurality of packets according to their respective priority levels and store and process the packets in units of the groups into which the packets are classified, may process the packets according to their respective internet protocol (IP) or media access control (MAC) addresses, or may divide the packets into a plurality of traffic flow groups with reference to MAC, IP, or transmission control protocol/user datagram protocol (TCP/UDP) port numbers of the packets and process the packets in units of the traffic flow groups. However, it is difficult to ensure fairness among a plurality of subscribers in a subscriber network by using any of the conventional packet processing methods.

In detail, in the conventional packet processing method in which a plurality of packets are classified and processed in units of groups into which they are classified, packets received from a plurality of subscribers may belong to the same group and may be processed together, thus failing to ensure fairness among the subscribers.

In the conventional packet processing method in which a plurality of packets are processed according to their respective IP or MAC addresses, it is almost impossible to determine to which of a plurality of subscribers each of the packets belongs, especially when each of the subscribers possesses one or more IP or MAC addresses. In addition, it is also difficult to ensure fairness among the subscribers because a subscriber having more IP or MAC addresses is more likely to occupy a larger bandwidth than a subscriber having less IP or MAC addresses.

In the conventional packet processing method in which a plurality of packets are divided into a plurality of traffic flow groups and then processed in units of the traffic flow groups, it is almost impossible to determine to which of a plurality of subscriber groups each of the traffic flow groups belongs, even though it is possible to guarantee the quality of service (QoS) of each of the traffic flow groups. For example, a subscriber with less traffic flow is likely to be discriminated against a subscriber with more traffic flow when serviced. In addition, this type of packet processing method places a large computational burden on each of a plurality of apparatuses for guaranteeing fairness among a plurality of subscribers in the subscriber network and requires a large storage capacity.

In other words, a conventional apparatus in a subscriber network does not classify or process a plurality of packets according to respective subscribers because, in a case where a subscriber network is expanded to have an arbitrary topology, it is impossible to obtain subscriber information identifying each of the subscribers until the subscribers are directly connected to the conventional apparatus. As a result, it is impossible for a plurality of subscriber lines to connect to the subscriber network to form an arbitrary topology while ensuring fairness among the subscribers by using the conventional packet processing methods.

### SUMMARY OF THE INVENTION

The present invention provides an apparatus and method for guaranteeing fairness among a plurality of subscribers in a subscriber network which can ensure that the same bandwidth is allotted to each of the subscribers even when the subscriber network is expanded to have an arbitrary topology, regardless of the locations of ports to which the subscribers are respectively connected.

The present invention also provides a computer-readable recording medium storing a computer program for executing the method of guaranteeing fairness among a plurality of subscribers in a subscriber network.

According to an aspect of the present invention, there is provided an apparatus for guaranteeing fairness among a plurality of subscribers in a subscriber network. The apparatus includes: a packet classification unit which classifies a plurality of packets received via at least one physical port by the subscribers; and a packet processing unit which performs a scheduling operation on the classified packet according to output order of the subscribers.

According to another aspect of the present invention, there is provided a method of guaranteeing fairness among a plurality of subscribers. The method includes: classifying a plurality of packets received via at least one physical port by subscribers; and performing a scheduling operation on the classified packets according to output order of the subscribers.

Therefore, it is possible to guarantee fairness among the subscribers even when the subscriber network is expanded to have an arbitrary topology.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram of an ideal subscriber network in which fairness among a plurality of subscribers is guaranteed;

FIG. 2 is a diagram of a tree structure representing a subscriber network for guaranteeing fairness among a plurality of subscribers;

FIG. 3 is a diagram of a typical conventional network that can be expanded to have an arbitrary topology;

FIG. 4 is a block diagram of an apparatus for guaranteeing fairness among a plurality of subscribers in a subscriber network according to an exemplary embodiment of the present invention;

FIG. 5 is a flowchart illustrating a method of guaranteeing fairness among a plurality of subscribers in a subscriber network according to an exemplary embodiment of the present invention;

FIG. 6 is a diagram illustrating the classifying of a plurality of packets into a plurality of subscriber groups corresponding to respective subscribers and the classifying of the packets classified into the subscriber groups into a plurality of traffic flow groups;

FIG. 7 is a flowchart illustrating a method of controlling traffic congestion in an apparatus for guaranteeing fairness among a plurality of subscribers in a subscriber network according to an exemplary embodiment of the present invention; and

FIG. 8 is a diagram of an example of the application of an apparatus for guaranteeing fairness among a plurality of subscribers in a subscriber network according to an exemplary embodiment of the present invention to a node 1 of FIG. 3.

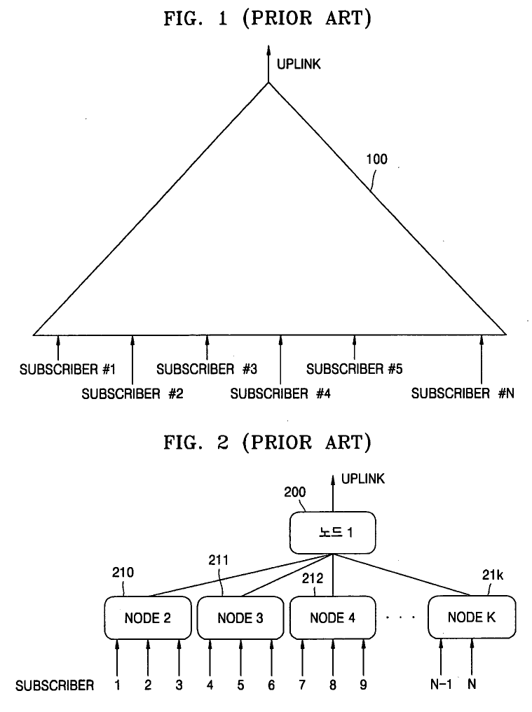

### DETAILED DESCRIPTION OF THE PREFERRED EMBODIMENT

The present invention will now be described more fully with reference to the accompanying drawings in which exemplary embodiments of the invention are shown.

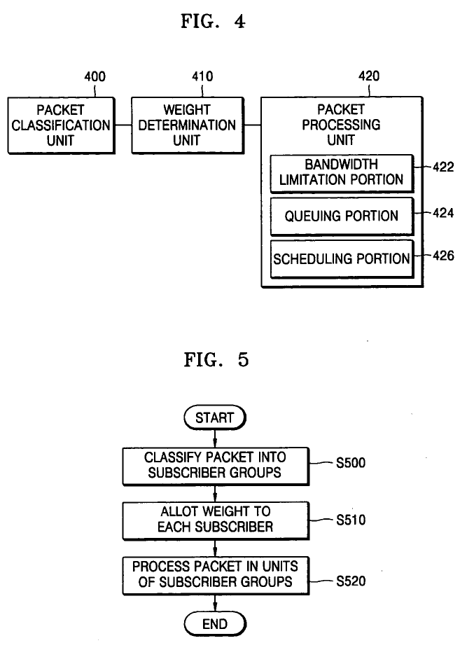

FIG. 4 is a block diagram of an apparatus for guaranteeing fairness among a plurality of subscribers in a subscriber network according to an exemplary embodiment of the present invention. Referring to FIG. 4, the apparatus includes a packet classification unit 400, a weight determination unit 410, and a packet processing unit 420. The packet processing unit 420 includes a bandwidth limitation portion 422, a queuing portion 424, and a scheduling portion 426.

The packet classification unit 400 classifies a plurality of packets into a plurality of subscriber groups corresponding to respective subscribers rather than into a plurality of groups corresponding to respective physical ports of the apparatus through which the packets have been received because a plurality of packets received via the same physical port may have been transmitted by the different physical ports of the sub node connected to the different subscribers.

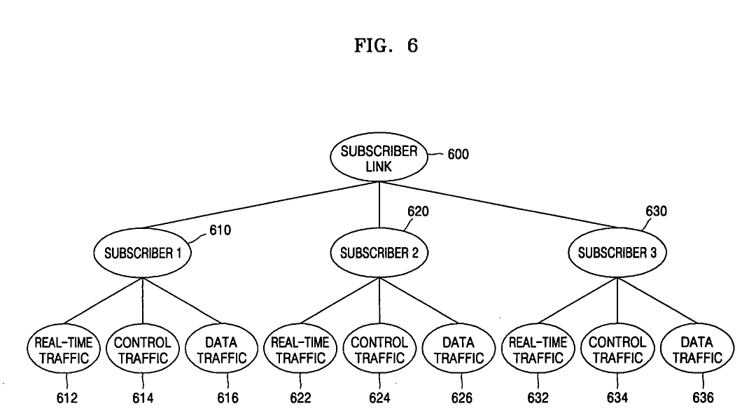

The packet classification unit 400 may classify the received packets into a plurality of traffic flow groups if each of the subscribers generates a plurality of traffic flows. For example, supposing that there is a subscriber 1, a subscriber 2, and a subscriber 3 in a subscriber network as illustrated in FIG. 6. The packets are classified into a subscriber 1 group 610, a subscriber 2 group 620, and a subscriber 3 group 630 according to the respective subscribers. The packets are further classified into the subscriber 1 group 610 into one of a real-time traffic group 612, a control traffic group 614, and a data traffic group 616. The packets are still further classified into the subscriber 2 group 620 into one of a real-time traffic group 622, a control traffic group 624, and a data traffic group 626; and the packets classified into the subscriber 3 group 630 are further classified into one of a real-time traffic group 632, a control traffic group 634, and a data traffic group 636. Rules used for further classifying the packets classified into the sub-groups may vary depending on network circumstances and are considered to be a design choice.

In order to facilitate the classification of the received packets, an additional tag containing subscriber information can be attached to an Ethernet frame, or an address table that contains a plurality of IP or MAC addresses used by the subscribers in the subscriber network and matches a plurality of source IP or MAC addresses with subscriber information of the respective subscribers may be used. Alternatively, the received packets may be classified according to the respective subscribers in the subscriber network by using a conventional packet classification method.

The weight determination unit 410 allots a weight value to each of the received packets corresponding to a service level to be provided to the respective subscribers. The weight determination unit 410 is used when different service levels are provided to different subscribers.

For example, if the subscriber 1 requests a premium service and the subscriber 2 requests a basic service, the weight determination unit 410 allots different weights to the packets for subscribers 1 and 2 in order to separately handle the packets of the subscribers 1 and 2 differently from each other. Stated alternatively, packets for subscriber 1 are given priority over the packets of subscriber 2. If all of the subscribers in the subscriber network request services at the same level, the same weight is allotted to each of the subscribers, in which case, the weight determination unit 410 is unnecessary.

The packet processing unit 420 performs a scheduling operation on the received packets in units of the subscriber groups into which the received packets are classified by the packet classification unit 400 or in units of the traffic flow groups into which the received packets are further classified by the packet classification unit 400 based on the weight values allotted to the received packets by the weight determination unit 410. The packet processing unit 420 includes the bandwidth limitation portion 422, the queuing portion 424, and the scheduling portion 426.

The bandwidth limitation portion 422 limits or controls a bandwidth allotted in advance to each of the subscriber groups or in order to maintain each of the traffic flow groups into which the received packets are classified to guaranty data packet handling fairness among the subscribers in the subscriber network. In addition, the bandwidth limitation portion 422 controls traffic congestion in the apparatus.

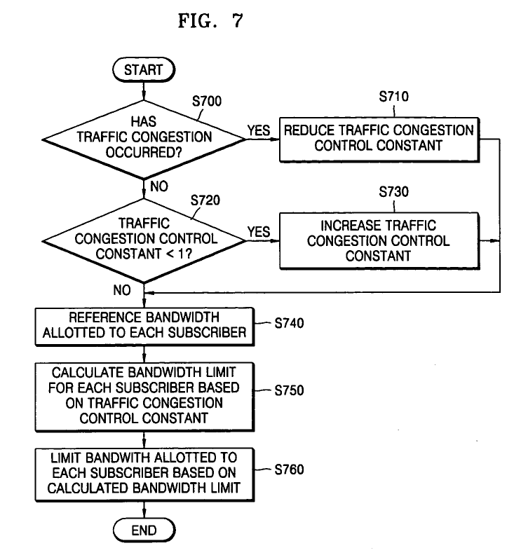

In detail, if traffic input to a predetermined port of the apparatus is congested, the bandwidth limitation portion 422 controls the traffic congestion by lowering a bandwidth limit below the level of a bandwidth allotted in advance to a subscriber connected to the predetermined port so that the number of packets that can be input to the apparatus decreases. The control of traffic congestion will be described later in further detail with reference to FIG. 7.

The queuing portion 424 stores the received packets in units of the subscriber groups into which the received packets are classified by the packet classification unit 400 or in units of the traffic flow groups into which the received packets classified into the subscriber groups are further classified by the packet classification unit 400. Thereafter, the scheduling portion 426 performs a scheduling operation on the received packets by equally dividing the bandwidth of an uplink and fairly distributing the divided bandwidth to the subscribers.

FIG. 5 is a flowchart illustrating a method of guaranteeing fairness among a plurality of subscribers in a subscriber network according to an exemplary embodiment of the present invention. Referring to FIG. 5, in operation S500, an apparatus for guaranteeing fairness among a plurality of subscribers in a subscriber network including at least one physical port classifies a plurality of received packets into a plurality of subscriber groups corresponding to respective subscribers rather than into a plurality of physical port groups corresponding to respective physical ports via which the packets are received. In operation S510, the apparatus allots a weight value to each of the received packets according to the service levels to be provided to the respective subscribers. In operation S520, the apparatus performs a scheduling operation on the received packets based on the weights allotted to the received packets.

FIG. 6 is a diagram illustrating the classifying of each of a plurality of packets according to which of a plurality of subscribers each of the packets belongs to or which of a plurality of traffic flow groups each of the packets belongs to. Referring to FIG. 6, a subscriber link 600 classifies a plurality of received packets into the subscriber 1 group 610, the subscriber 2 group 620, and the subscriber 3 group 630 corresponding to subscribers 1, 2, and 3, respectively. Thereafter, the subscriber link 600 further classifies: the packets classified into the subscriber 1 group 610 into one of a real-time traffic group 612, a control traffic group 614, and a data traffic group 616; the packets classified into the subscriber 2 group 620 into one of a real-time traffic group 622, a control traffic group 624, and a data traffic group 626; and the packets classified into the subscriber 3 group 630 into one of a real-time traffic group 632, a control traffic group 634, and a data traffic group 636.

FIG. 7 is a flowchart illustrating a method of controlling traffic congestion in an apparatus for guaranteeing fairness among a plurality of subscribers in a subscriber network according to an exemplary embodiment of the present invention. Referring to FIG. 7, the apparatus limits bandwidth and controls traffic congestion by using a traffic congestion control constant. In operation S700, it is determined whether traffic is congested. In operation S710, if it is determined that traffic is congested, the traffic congestion control constant is decreased. In operation S720, if the traffic congestion is removed, the traffic congestion control constant is increased. For example, if the traffic congestion control constant is originally set to a value between 0 and 1, the severer the traffic congestion, the closer the traffic congestion control constant is set to a value of 0. When the traffic congestion is removed, the traffic congestion control constant has a value close to 1.

In operation S740, the bandwidth allotted to each of a plurality of subscribers is referenced. In operation S750, a bandwidth limit is calculated based on the traffic congestion control constant. In operation S760, the calculated bandwidth limit is imposed on each of the subscribers.

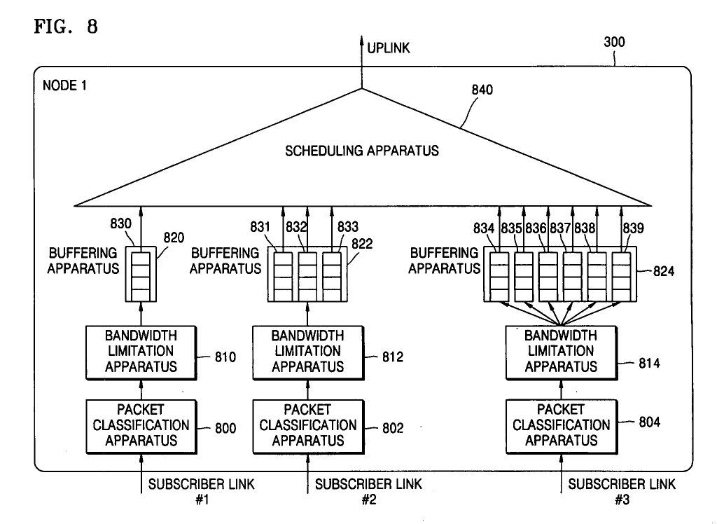

FIG. 8 is a diagram illustrating an example of the application of an apparatus for guaranteeing fairness among a plurality of subscribers in a subscriber network according to an exemplary embodiment of the present invention. Referring to FIG. 8, the node 1 (300) includes 1 uplink and 3 subscriber links 1, 2, and 3. The subscriber links 1, 2, and 3 include packet classification apparatuses 800, 802, and 804, respectively, bandwidth limitation apparatuses 810, 812, and 814, respectively, and buffering apparatuses 820, 822, and 824, respectively.

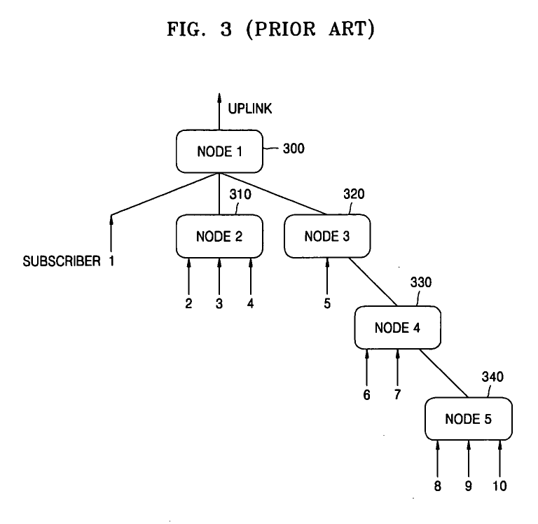

Since only one subscriber, i.e., the subscriber 1, is connected to the subscriber link 1 corresponding to the node 1 (300) of FIG. 3, the subscriber-wise buffering apparatus 820 forms a virtual buffer 830 for the subscriber link 1. The subscribers 2, 3, and 4 are connected to the subscriber link 2 corresponding to the node 2 (310) of FIG. 3. Thus, the subscriber-wise packet classification apparatus 802 classifies a plurality of packets received from the subscribers 2, 3, and 4 into subscriber 2, 3, and 4 groups, the subscriber-wise bandwidth limitation apparatus 812 limits a bandwidth allotted to each of the subscribers 2, 3, and 4, and the subscriber-wise buffering apparatus 822 forms virtual buffers 831, 832, and 833 for the subscribers 2, 3, and 4, respectively, and stores the received packets in units of the subscriber 2, 3, and 4 groups into which the received packets are classified.

The subscribers 5, 6, 7, 8, 9, and 10 are connected to the subscriber link 3 corresponding to the nodes 320, 330, and 340 of FIG. 3. Thus, the subscriber-wise packet classification apparatus 804 classifies a plurality of packets received from the subscribers 5, 6, 7, 8, 9, and 10 into subscriber 5, 6, 7, 8, 9, and 10 groups. The subscriber-wise bandwidth limitation apparatus 814 limits a bandwidth allotted to each of the subscribers 5, 6, 7, 8, 9, and 10. The subscriber-wise buffering apparatus 824 forms virtual buffers 834, 835, 836, 837, 838, and 839 for the subscribers 5, 6, 7, 8, 9, and 10, respectively, and stores the received packets in units of the subscriber 5, 6, 7, 8, 9, and 10 groups into which the received packets are classified. Therefore, the node 1 (300) performs bandwidth limitation and scheduling operations in consideration of a plurality of subscriber ports including those of lower nodes instead of the subscriber links 1 through 3.

For example, when performing the scheduling operation, bandwidths are not allotted to the subscriber links 1 through 3 but to the virtual buffers of each of the subscriber links 1 through 3 in which the packets received from the subscribers 1 through 10 are stored. In other words, supposing that the subscribers 1 and 9 have the same weight value, the same bandwidth is allotted to the virtual buffer 830 for the subscriber 1 and the virtual buffer 838 for the subscriber 9 when transmitting packets to the uplink. In addition, the bandwidth limitation operation is performed on each of the subscribers 1 through 10.

For example, if the same bandwidth is allotted to the subscribers 1 and 9 in advance, the subscribers 1 and 9 may suffer from packet loss when the traffic of the subscribers 1 and 9 overflows the bandwidth allotted thereto. Therefore, in a subscriber network connected to the apparatus for guaranteeing fairness among a plurality of subscribers in a subscriber network according to the present invention, a subscriber connected to an uplink via a plurality of nodes and a subscriber directly connected to the uplink are treated exactly alike, thereby guaranteeing fairness among the plurality of subscribers.

Those of ordinary skill in the art will recognize that the present invention can be implemented using one or more computers (omitted from the figures for clarity and simplicity), which execute computer program instructions stored or written on a computer-readable recording medium. Those of ordinary skill in the art will also recognize that such computer-readable recording medium can include semiconductor ROM, RAM, EEPROM and EPROM. Other computer-readable media on which the program instructions can be stored include optical disks, such as CD-ROM, magnetic disks, and magnetic tape. Computer program instructions stored on media can also be distributed by carrier wave (e.g., radio frequency transmission but also data transmission through the Internet). The computer program instructions can be distributed over a plurality of computer systems connected to a network so that a computer-readable code is written thereto and executed therefrom in a decentralized manner. Program instructions and program architecture needed for realizing the present invention are well known to those of ordinary skill in the computer programming art.

According to the present invention, it is possible to fairly distribute bandwidths to subscribers in a subscriber network regardless of the locations of ports to which the subscribers are connected, when the subscriber network is expanded to have an arbitrary topology.

In other words, when the subscriber network is expanded to have an arbitrary topology, traffic can be classified into one of a plurality of subscriber groups corresponding to a corresponding subscriber. Thus, traffic can be processed in units of the subscriber groups. As a result, the subscribers are prevented from being discriminated against one another in terms of traffic processing, even though their locations in the subscriber network are different from one another. Thus, it is possible to guarantee fairness among the subscribers.

In addition, in the method of guaranteeing fairness among a plurality of subscribers in a subscriber network according to the present invention, a plurality of subscribers in a subscriber network can be easily classified into subscribers connected to an upper node of the subscriber network and subscribers connected to a lower node of the subscriber network with less computation and less communication. Thus, it is possible to efficiently guarantee fairness among the subscribers with less effort while easily expanding and managing the subscriber network.

Moreover, according to the present invention, a subscriber having a bundle of IP or MAC addresses can use a bandwidth allotted in various manners. For example, if a subscriber is allotted a bandwidth of 100 Mbps and possesses 5 IP addresses, the subscriber may be able to use a bandwidth of 20 Mbps for each of the 5 IP addresses or to allot a bandwidth of 60 Mbps to one of the 5 IP addresses and allot a bandwidth of 10 Mbps to each of the remaining 4 IP addresses.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for guaranteeing fairness among a plurality of subscribers in a subscriber network comprising:
a packet classification unit which classifies a plurality of packets received via at least one physical ports; and
a packet processing unit coupled to the packet classification unit to receive packets there from and which performs a scheduling operation on the classified packets according to a predetermined packet output order.

2. The apparatus of claim 1 further comprising:
a weight determination unit which allots a weight to each of the received packets in consideration of service levels provided to subscribers, and
wherein, the packet processing unit performs the scheduling operation by determining an order that the received packets are to be output, using weights assigned to the received packets.

3. The apparatus of claim 1, wherein the packet classification unit searches a subscriber address table including IP or MAC addresses of a plurality of subscribers for an IP or MAC address related to each of the received packets and classifies each of the received packets by subscribers based on the search results.

4. The apparatus of claim 1, wherein the packet classification unit receives a packet into which a tag comprising subscriber information is inserted and which classifies the received packet by subscribers based on the tag.

5. The apparatus of claim 1, wherein the packet classification unit further classifies the classified packets into a plurality of traffic flows, and the packet processing unit performs the scheduling operation in units of the traffic flows.

6. The apparatus of claim 1, wherein the packet processing unit comprises:
a bandwidth limitation unit which controls packet congestion for each of the at least one physical ports;
a queuing unit which stores the classified packets; and
a scheduling unit which performs a scheduling operation on the classified packets that are stored in the queuing unit.

7. The apparatus of claim 6, wherein the bandwidth limitation unit reduces the number of received packets by reducing the bandwidth allotted to each of the subscribers when packet congestion occurs.

8. The apparatus of claim 6, wherein the queuing unit stores the received packets that classified by the subscribers in units of traffic flows.

9. The apparatus of claim 5, wherein the traffic flows comprise real-time traffic, control traffic, and data traffic.

10. A method of guaranteeing fairness among a plurality of subscribers comprising:
classifying a plurality of packets received via at least one physical port by subscribers; and
performing a scheduling operation on the classified packets according to a predetermined output order.

11. The method of claim 10 further comprising:
allotting a weight value to each of the received packets in consideration of service levels provided to the subscribers, and
wherein the step of performing a scheduling operation comprises determining in what order the received packets are to be output based on the weights allotted to the received packets.

12. The method of claim 10, wherein the step of classifying comprises: searching a subscriber address table that comprises IP or MAC addresses of a plurality of subscribers for an IP or MAC address of each of the received packets and classifying each of the received packets by subscribers based on the search results.

13. The method of claim 10, wherein the step of classifying comprises: receiving a packet into which a tag comprising subscriber information is inserted and classifying the received packet by subscribers based on the tag.

14. The method of claim 10, wherein the step of classifying comprises: classifying the classified packets into a plurality of traffic flows and the scheduling operation is performed in units of the traffic flows.

15. The method of claim 10, wherein the step of performing a scheduling operation comprises:
controlling packet congestion for each of the physical ports;
storing the received packets classified by the subscribers; and
scheduling the classified packets that are stored, according to a predetermined output order.

16. The method of claim 15, wherein the step of controlling packet congestion comprises: reducing the number of received packets by reducing the bandwidth allotted to each of the subscribers.

17. The method of claim 15, wherein the step of storing received packets comprises: storing the received packets that classified by the subscribers in units of the traffic flows.

18. The method of claim 14, wherein the traffic flows comprise: a real-time traffic group, a control traffic group, and a data traffic group.

19. A computer-readable medium storing computer program instructions, which when executed guarantees service fairness to a plurality of subscribers in a subscriber network, the method comprising:
classifying a plurality of packets received via at least one physical port by subscribers; and
performing a scheduling operation on the classified packets according to a predetermined output order of the subscribers' packets.
